(19) United States
(12) Patent Application Publication
(10) Pub. No.: US 2023/0347407 A1
(43) Pub. Date: Nov. 2, 2023

(54) BONDING MATERIAL, METHOD FOR PRODUCING BONDING MATERIAL, AND BONDED BODY

(71) Applicant: TAIYO NIPPON SANSO CORPORATION, Tokyo (JP)

(72) Inventors: Kentaro MIYOSHI, Tokyo (JP); Hiroshi IGARASHI, Tokyo (JP)

(21) Appl. No.: 18/219,927

(22) Filed: Jul. 10, 2023

Related U.S. Application Data
(62) Division of application No. 17/790,823, filed on Jul. 5, 2022.

(30) Foreign Application Priority Data
Jan. 24, 2020 (JP) 2020-010052

(51) Int. Cl. B22F 1/00; B22F 1/06; B22F 7/08; B23K 35/30; B22F 1/05; B22F 1/054; B22F 1/052; B22F 1/145; B23K 35/02

(52) U.S. Cl. CPC B22F 1/00; B22F 1/06; B22F 7/08; B23K 35/302; B22F 1/05; B22F 1/056; B22F 1/052; B22F 1/145; B23K 35/0244; B22F 2301/10

(57) ABSTRACT

A method for producing a bonding material having a plate shape or a sheet shape includes a mixture producing step in which fine copper particles having an average particle diameter of 300 nm or less, coarse copper particles having an average particle diameter of 3 μm or more and 11 μm or less, and a reducing agent which reduces the fine copper particles and the coarse copper particles are mixed to produce a mixture: and a molding step in which the mixture is formed in a plate shape or a sheet shape.

### CROSS REFERENCE TO RELATED APPLICATIONS

This application is a divisional of U.S. application Ser. No. 17/790,823, filed Jul. 5, 2022, which is the U.S. national phase of International Application No. PCT/JP2021/000286 filed Jan. 7, 2021 which designated the U.S. and claims priority to JP 2020-010052 filed Jan. 24, 2020, the entire contents of each of which are hereby incorporated by reference.

### TECHNICAL FIELD

The present invention relates to a bonding material, a method for producing a bonding material, and a bonded body.

### BACKGROUND ART

Conventionally, a solder material has been widely used as a bonding material for electronic components. However, the solder material has a problem of poor heat resistance. Therefore, for example, in a power device (hereinafter, also referred to as “SiC power device”) using a SiC element (hereinafter, also referred to as “SiC chip”), which is expected to subject with a high temperature of 150° C. or higher, a solder material hardly is used as a bonding material.

Therefore, as a sintered-type bonding material, a bonding material using silver particles has been proposed. Further, as copper particles, copper nanoparticles are expected from the viewpoint of cost and ion migration.

As a bonding material which has a sheet shape, and contains copper nanoparticles as a raw material, Patent Document 1 discloses a bonding material which has a sheet shape, and does not require a reducing gas during the production of the bonding material and the bonding of members, and enables stable bonding in an inert atmosphere.

### PRIOR ART DOCUMENTS

### Patent Documents

Patent Document 1 Japanese Unexamined Patent application, First Publication No. 2019-203172

### SUMMARY OF INVENTION

### Problem to be Solved by the Invention

By the way, when a SiC chip and a copper plate are bonded by using the bonding material disclosed in Patent Document 1, since the difference in the coefficient of linear expansion between the members to be bonded is large, when bonding the SiC chip and the copper plate, or when a bonded body of the SiC chip and the copper plate is subjected to thermal shock (for example, heating from −40° C. to 150° C., cooling from 150° C. to −40° C., or repeating heating and cooling), there was a risk that the SiC chip could not withstand the stress and cracks would occur in the SiC chip. Further, when the pressure at the time of bonding the SiC chip and the copper plate is reduced, the bond strength is lowered, there is a problem in which the bonded body cannot withstood the thermal shock (heat cycle), and peeling occurs between the bonded members.

The present invention has been made in view of the above circumstances, and an object of the present invention is to provide a bonding material capable of forming a highly reliable bond, a method for producing a bonding material, and a bonded body.

### Means for Solving the Problem

In order to achieve the object, the present invention provides the following bonding material, a method for producing a bonding material, and a bonded body.
[1] A bonding material having a plate shape or a sheet shape,
   wherein the bonding material includes:
   fine copper particles having an average particle diameter of 300 nm or less;
   coarse copper particles having an average particle diameter of 3 μm or more and 11 μm or less; and
   a reducing agent which reduces the fine copper particles and the coarse copper particles.
[2] The bonding material according to [1],
   wherein the mass ratio of the fine copper particles to the coarse copper particles is in a range of 7.5:2.5˜5:5.
[3] The copper fine particles according to [1] or [2],
   wherein the reducing agent includes at least one of a polyol solvent and an organic acid.
[4] The bonding material according to [3],
   wherein the reducing agent further includes at least one of sodium borohydride and hydrazine.
[5] The bonding material according to any one of [1] to [4],
   wherein the amount of the reducing agent is 1.52% by mass or more and less than 11.1% by mass with respect to a total of 100% by mass of the fine copper particles and the coarse copper particles.
[6] The bonding material according to any one of [1] to [5],
   wherein the ratio of the mass oxygen concentration to the specific surface area of the fine copper particles is in a range of 0.1˜1.2% by mass·g/m².
[7] The bonding material according to any one of [1] to [6],
   wherein the ratio of the mass carbon concentration to the specific surface area of the fine copper particles is in a range of 0.008˜0.3% by mass·g/m².
[8] The bonding material according to any one of [1] to [7],
   wherein the thickness is in a range of 100˜1,000 μm.
[9] The bonding material according to any one of [1] to [8],
   wherein the indentation hardness is less than 900 N/mm².
[10] A method for producing a bonding material having a plate shape or a sheet shape,
   wherein the method includes:
   a mixture producing step in which fine copper particles having an average particle diameter of 300 nm or less, coarse copper particles having an average particle diameter of 3 μm or more and 11 μm or less, and a reducing agent which reduces the fine copper particles and the coarse copper particles are mixed to produce a mixture: and
   a molding step in which the mixture is formed in a plate shape or a sheet shape.
[11] A bonded body,
   wherein the bonded body includes a first bonded member, a second bonded member, and a bonding material according to any one of [1] to [9], and
   the bonding material is located between the first bonded member and the second bonded member.
[12] The bonded body according to [11],
   wherein a difference in a linear expansion coefficient between the first bonded member and the second bonded member is two times or more.
[13] The bonded body according to [11] or [12],
   wherein a shear strength is 35 MPa or more.
[14] The bonded body according to any one of [11] to [13],
   wherein in a load displacement curve (vertical axis: kg-horizontal axis: μm) obtained at the time of shear strength measurement, when a curve from an inflection point to before the load saturates is approximated by a linear function, the slope of a straight line of the linear function is less than 1.

### Effects of the Invention

The bonding material of the present invention enables bonding having good adhesion on the bonding surface and excellent reliability. In particular, when the bonding material of the present invention is used for bonding two or more members made of materials having a large difference in linear expansion coefficient, either when the members are bonded or when the bonded body including bonded members is subjected to thermal shock, the members are not damaged. This enables bond having good adhesion on the bonding surface and excellent reliability.

The method for producing a bonding material of the present invention can produce the bonding material above.

The bonded body of the present invention has good adhesion on the bonding surface and is excellent in bond reliability.

### BRIEF DESCRIPTION OF DRAWINGS

FIG. 1 is a perspective view showing an example of a jig for producing a bonding material used in verification tests of the present invention.

FIG. 2 is a perspective view explaining a bonded body used in verification tests of the present invention.

FIG. 3 shows a slope of a straight line of a linear function when a curve from the inflection point to before the load is saturate is approximated by a linear function in a load displacement curve (vertical axis: kg-horizontal axis: μm) obtained when measuring the shear strength of the bonding surface of the first member to be bonded and the second member to be bonded.

### DETAILED DESCRIPTION OF THE PREFERRED EMBODIMENTS

Hereinafter, a bonding material and a bonded body, which are embodiments according to the present invention, will be described in detail with reference to the drawings together with their producing methods. In addition, in the drawings used in the following explanation, in order to make the features easy to understand, the featured parts may be enlarged for convenience, and the dimensional ratios of each component may not be the same as the actual ones.

The meaning of the following terms in the present description are as follows.

The “average particle diameter” of copper particles (including fine copper particles and coarse copper particles; the same applies hereinafter) means the diameter of a sphere when the copper particles are spherical. When copper particles are ellipsoidal spheres, the “average particle diameter” means the length in the major axis direction. When copper particles are in a plate shape, the “average particle diameter” means the length in the major axis direction.

The average particle size is a value measured by an SEM (scanning electron microscope).

The “mass oxygen concentration” of copper particles is a value measured by an oxygen-nitrogen analyzer (for example, “TC600” manufactured by LECO).

The “mass carbon concentration” of copper particles is a value measured by a carbon-sulfur analyzer (for example, “EMIA-920V” manufactured by HORIBA, Ltd.).

The “indentation hardness” is a value measured by an ultrafine hardness tester (for example, “DUH-211” manufactured by Shimadzu Corporation).

The “shear strength” is a value measured by a commercially available bond tester device (for example, “4000Plus” manufactured by Dage).

The “˜” indicating the numerical range means that the numerical values described before and after it are included as the lower limit value and the upper limit value.

<Bonding Material>

First, a bonding material, which is an embodiment according to the present invention, will be described.

The bonding material of the present embodiment includes fine copper particles, coarse copper particles, and a reducing agent. The fine copper particles are smaller than the coarse copper particles. The coarse copper particles are larger than the fine copper particles.

The fine copper particles contain copper as the main component. The fine copper particles preferably contain 95% by mass or more of copper element with respect to 100% by mass of the fine copper particles, and more preferably 97% by mass or more. When the copper element is contained in an amount of 95% by mass or more, the heat resistance of the bonding material is excellent, and the bonding force is further excellent.

The average particle size of the fine copper particles is 300 nm or less. However, the average particle size of the fine copper particles is more preferably 150 nm or less. When the average particle size of the fine copper particles is 300 nm or less, the bonding material has excellent bonding force. The average particle size of the fine copper particles is preferably 5 nm or more, and more preferably 50 nm or more. When the average particle size of the fine copper particles is 5 nm or more, it becomes easy to obtain the fine copper particles. On the other hand, when it is 50 nm or more, the specific surface area of the fine copper particles becomes small and the oxygen concentration becomes low, so that the oxide film covering the surface of the fine copper particles can be easily removed and the bond force becomes stronger.

The shape (form) of the fine copper particles is not particularly limited. Examples of the shape of the fine copper particles include a spherical shape (sphere shape), an elliptical shape (ellipsoidal sphere shape), a plate shape, and the like. Among these, a spherical shape or an elliptical shape is preferable, and a spherical shape is more preferable.

As the fine copper particles, it is preferable to use the fine copper particles that do not require a protective agent, a dispersant, or the like. Examples of such fine copper particles include ultrafine metal powders obtained by the production method disclosed in Japanese Patent No. 4304221. However, the fine copper particles are not limited to this example.

The coarse copper particles contain copper as the main component. The coarse copper particles preferably contain 95% by mass or more of copper element with respect to 100% by mass of the coarse copper particles, and more preferably 97% by mass or more. When the copper element is contained in an amount of 95% by mass or more, the sintering property of the bonding material is excellent, and the bonding force is further excellent.

The average particle size of the coarse copper particles is 3 μm or more and 11 μm or less, and preferably 5 μm or more and 9 μm or less. When the average particle size of the coarse copper particles is 3 μm or more, the shrinkage of the fine copper particles is reduced when the bonding material is sintered, and the cracking of the member bonded is suppressed. When the average particle size of the coarse copper particles is 11 μm or less, the bonding material which becomes a bonding layer can be sufficiently sintered while maintaining the effect of reducing the shrinkage of the fine copper particles, and the bond strength of the bonded body is not impaired.

The shape (form) of the coarse copper particles is not particularly limited. Examples of the shape of the coarse copper particles include a spherical shape (sphere shape), an elliptical shape (ellipsoidal sphere shape), a plate shape (flake shape), and the like. Among these, a spherical shape or an elliptical shape is preferable, and an elliptical shape is more preferable.

Examples of the coarse copper particles include commercially available flake copper such as “MA-C03KP” manufactured by Mitsui Mining & Smelting Co., Ltd. and “MA-C025KFD” manufactured by Mitsui Mining & Smelting Co., Ltd., and commercially available micro copper such as “1300Y” manufactured by Mitsui Mining & Smelting Co., Ltd.

In the bonding material of the present embodiment, the fine copper particles preferably have a coating film containing copper carbonate on their surface. The coating on the surface of the fine copper particles may further contain cuprous oxide.

By the way, in the conventional fine copper particles, the surface is oxidized to inevitably form a film made of cuprous oxide, so that the dispersibility may be lowered. Further, in the conventional fine copper particles, carbon adhering to the surface in the producing process may be present, so that the bond force may decrease.

On the other hand, in the bonding material of the present embodiment, when the fine copper particles have a coating film containing copper carbonate on their surface, the sintering temperature of the fine copper particles can be suppressed to be lower than in the conventional case. Therefore, when the fine copper particles contain copper carbonate in the coating film, the bonding force can be increased while keeping the sintering temperature of the fine copper particles low. In addition, the fine copper particles containing copper carbonate are sintered, so that they are also necked to the coarse copper particles, and the entire copper fired layer is strengthened.

The ratio of the mass oxygen concentration to the specific surface area of the fine copper particles is preferably 0.1˜1.2% by mass·g/m², and more preferably 0.2˜0.5% by mass·g/m². When the ratio of the mass oxygen concentration is 0.1% by mass·g/m² or more, the reactivity with oxygen in the air becomes low, and it becomes easy to reduce the influence of reoxidation. When the ratio of the mass oxygen concentration is 1.2% by mass·g/m² or less, the oxide film can be easily removed at the time of bonding, and the bonding force becomes stronger.

The ratio of the mass carbon concentration to the specific surface area of the fine copper particles is preferably 0.008˜0.3% by mass·g/m², more preferably 0.008˜0.1% by mass·g/m², and most preferably 0.008˜0.05% by mass·g/m². When the ratio of the mass carbon concentration is 0.3% by mass·g/m² or less, voids and cracks are less likely to occur, and the bond force is further excellent.

In the bonding material of the present embodiment, the mass ratio between the fine copper particles and the coarse copper particles is in the range of 7.5:2.5˜5:5. That is, the fine copper particles are 50% by mass or more and 75% by mass or less, and the coarse copper particles are 25% by mass or more and 50% by mass or less with respect to 100% by mass of the total amount of the fine copper particles and the coarse copper particles.

When the ratio of the fine copper particles with respect to 100% by mass of a total of the fine copper particles and the coarse copper particles is 50% by mass or more (the ratio of the coarse copper particles is 50% by mass or less), the bonding material has sufficient bonding force.

When the ratio of the coarse copper particles to 100% by mass of the fine copper particles and the coarse copper particles is 25% by mass or more (the ratio of the fine copper particles is 75% by mass or less), when sintering the bonding material, shrinkage of the fine copper particles can be reduced.

The reducing agent is a compound that reduces the fine copper particles and the coarse copper particles. The reducing agent is preferably a compound capable of functioning as a dispersion medium in which the fine copper particles and the coarse copper particles are dispersed.

The compound that can function as a dispersion medium is preferably a compound that is liquid at room temperature, and more preferably a compound that is liquid and vaporizes at a high temperature of 150° C. or higher. As a result, the reducing agent is vaporized at the time of bonding, and the reducing agent is less likely to remain in the bonded body described later. Thereby, voids and cracks are less likely to occur, and the bond force is further improved.

Examples of the reducing agent capable of functioning as a dispersion medium include a polyol solvent and an organic acid. That is, the reducing agent preferably contains either one or both of a polyol solvent and an organic acid. As a result, the formability of the bonding material is excellent, and the bonding force is also excellent.

Specific examples of the polyol solvent include ethylene glycol, diethylene glycol, triethylene glycol, polyethylene glycol, 1,2-propanediol, 1,3-propanediol, 1,2-butanediol, 1,3-butanediol, 1,4-butanediol, 2-butane-1,4-diol, 1,2,6-hexanetriol, glycerin, and 2-methyl-2,4-pentanediol. These may be used alone or a combination of two or more may be used.

As the polyol solvent, ethylene glycol, diethylene glycol and triethylene glycol are preferable.

Specific examples of the organic acid include formic acid, acetic acid, propionic acid, citric acid, stearic acid, and ascorbic acid. These may be used alone or a combination of two or more may be used. As the organic acid, formic acid and citric acid are preferable.

When a solid reducing agent such as sodium boron hydroxide or hydrazine is used as the reducing agent, it is preferable to use a reducing agent that can function as a dispersion medium for a liquid such as the polyol solvent or the organic acid. In this case, a reducing agent prepared by mixing a liquid reducing agent and a solid reducing agent in advance is used.

The amount of the reducing agent is preferably 1.52% by mass or more and less than 11.1% by mass, and preferably 5.5% by mass or more and less than 7.5% by mass, with respect to 100% by mass of a total of the fine copper particles and the coarse copper particles.

When the amount of the reducing agent is 1.52% by mass or more with respect to the total of 100% by mass of the fine copper particles and the coarse copper particles, the bonding force when bonding in a nitrogen atmosphere is further excellent, and a bond force which is higher than the bond force at the time of bonding in a reducing atmosphere can be obtained.

When the amount of the reducing agent is less than 11.1% by mass with respect to the total of 100% by mass of the fine copper particles and the coarse copper particles, voids and cracks are less likely to occur, the bonding force is further excellent, and the bonding material can be easily made into a plate shape or a sheet shape.

The bonding material of the present embodiment may further contain an arbitrary component such as a dispersant in addition to the fine copper particles, the coarse copper particles, and the reducing agent as long as the effects of the present invention are not impaired.

As described later, the bonding material of the present embodiment is formed by mixing the fine copper particles and the coarse copper particles with a required reducing agent and pressure-molding the mixed particles (mixture) in the air to form in a plate shape or a sheet shape. The thickness of the bonding material (thickness in the pressurizing direction) is not particularly limited and may be appropriately selected depending on the mode of the bonding material such as a plate shape or a sheet shape. From the viewpoint of stress relaxation, it is preferably 100 μm or more and less than 1 mm, and more preferably 200 μm or more and less than 600 μm.

Further, the shape of the bonding material (the shape when viewed in a plan view from the thickness direction) is not particularly limited, and can be appropriately selected depending on the shape of the bonding surface of a member to be bonded. The shape of the bonding material may be a shape of a pressurized surface when the mixed particles explained above is pressure-molded at a required pressure to form in a plate shape or a sheet shape. Specific examples thereof include a rectangle shape and a circle shape.

(Action Effects)

As described above, according to the bonding material of the present embodiment, since the fine copper particles, the coarse copper particles, and the reducing agent are contained, the high surface activity of the fine copper particles and the coarse copper particles can be easily maintained. Therefore, even when the members are bonded in an inert atmosphere, excellent bonding force can be exhibited.

Further, according to the bonding material of the present embodiment, since the copper particles include the coarse copper particles in addition to the fine copper particles, the shrinkage of the fine copper particles is reduced when the bonding material is sintered. Therefore, when the bonded body is molded, cracks of the bonded members can be suppressed.

Moreover, since the bonding material of the present embodiment is in a sheet shape, it is easier to handle than a conventional paste product. Furthermore, it is easy to maintain the dispersibility of the fine copper particles even when the bonding material is stored for a long period of time. In addition, there is no need to freeze, and there is no need to mix a large amount of the dispersant. As a result, the quality of the bonding material and the bonded body described later is excellent.

Further, in the bonding material of the present embodiment, the fine copper particles (copper nanoparticles) which have high sinterability and enhance bond strength, and the coarse copper particles (copper microparticles) which prevent shrinkage of the copper nanoparticles during sintering, relieve stress generated in the bonding material, and soften the hardness of the bonding layer, are blended in an appropriate ratio. Therefore, the bonding material of the present embodiment can relieve the stress generated at the time of bonding or thermal shock while the bonding material has high strength. As a result, cracking of the bonded members does not occur, and a highly reliable bonding becomes possible.

<Producing Method of Bonding Material>

Next, the producing method of a bonding material, which is an embodiment according to the present invention, will be described.

The method for producing a bonding material of the present invention is the method for producing the bonding material (bonding material having a plate shape or a sheet shape) according to the embodiment above.

Therefore, the details of the fine copper particles, the coarse copper particles, and the reducing agent, as well as the preferred embodiments, are the same as those described above in the section “<Bonding material>”. Further, the amounts of each of the fine copper particles, the coarse copper particles, and the reducing agent are also the same as those described above in the section of “<Bonding material>”.

First, in the method for producing a bonding material of the present embodiment, the fine copper particles, the coarse copper particles and the reducing agent are mixed to obtain mixed particles (mixture).

The method of mixing the fine copper particles, the coarse copper particles, and the reducing agent is not particularly limited. Examples of the mixing method include a method using a self-revolving mixer, a mortar, a mill stirrer, a stirrer, and the like.

When the reducing agent contains either or both of the polyol solvent and the organic acid, the reducing agent may further contain either or both of sodium boron hydroxide and hydrazine. These may be used alone or a combination of two or more may be used.

Next, in the method for producing a bonding material of the present embodiment, the obtained mixed particles (mixture) are pressed to form a plate or a sheet.

The pressurizing method is not particularly limited. Examples of the pressurizing method include a method using a metal jig, a pressure-molding machine, and the like.

The atmosphere when pressurizing is not particularly limited, and may be an inert atmosphere or a reducing atmosphere. However, from the viewpoint of convenience, it is preferable to pressurize in an inert atmosphere such as in the atmosphere.

The pressure at the time of pressurization is preferably 10 MPa or more, and more preferably 40 MPa or more. When the pressure at the time of pressurization is 10 MPa or more, the durability of the product molded into a sheet shape becomes high. Further, the higher the pressing force, the higher the density of the fine copper particles contained in the bonding material, and the higher the shear strength of the bonding surface of the bonded body described later.

The molding temperature at the time of pressurization is preferably 200° C. or higher and 400° C. or lower, and more preferably 250° C. or higher and 350° C. or lower. When the molding temperature at the time of pressurization is within the preferable range above, the bond strength can be ensured while suppressing the thermal shock of the bonded material at the time of bonding.

The molding time at the time of pressurization is not particularly limited. The molding time can be, for example, 1˜10 minutes.

(Action Effects)

As described above, the method for producing a bonding material of the present embodiment includes a mixed particle production step in which the fine copper particles, the coarse copper particles, and the reducing agent are mixed to produce mixed particles, and a molding step in which the produced mixed particles are pressurized to form in a plate shape or a sheet shape. Accordingly, a bonding material can be produced while maintaining the high surface activity of the fine copper particles. Therefore, according to the method for producing a bonding material of the present embodiment, it is possible to produce a bonding material having excellent bond strength and excellent bond reliability even when the members are bonded in an inert atmosphere.

Further, according to the method for producing a bonding material of the present embodiment, the reducing agent that reduces the fine copper particles and the coarse copper particles is used as a raw material for the bonding material. Therefore, even when the bonding material is produced in an inert atmosphere, the bonding material having excellent bonding strength and excellent bond reliability can be produced.

<Bonded Body>

Next, a bonded body using the bonding material above will be described.

A bonded body of the present embodiment includes a first member (first member to be bonded), a second member (second member to be bonded), and a pressurized material of the bonding material described above. In the bonded body, the pressurized material of the bonding material is located between the first member and the second member. The first member and the second member are bonded by the bonding material.

The materials of the first member and the second member are not particularly limited as long as they are bonded when being pressure-bonded using the bonding material described above. Examples of such a material include metals such as copper, silicon, aluminum, copper oxide, silicon oxide, alumina, silicon nitride, aluminum nitride, boron nitride and silicon carbide; alloys thereof and mixtures thereof. The first member and the second member may be those using one kind of material alone or those using two or more kinds of materials in combination. The first member and the second member may be made of the same material or may be made of different materials.

Since the bonded body of the present embodiment is bonded using the bonding material described above, the difference between the linear expansion coefficient of the first member and the linear expansion coefficient of the second member may be two times or more, or four times or more.

In this way, when the difference in the linear expansion coefficient between the bonded members is two times or more, when pressure bonding is performed using a bonding material containing conventional copper particles as the main component, and when members are bonded or when the bonded body is subjected to thermal shock (for example, heating from −40° C. to 150° C., cooling from 150° C. to −40° C., or repetition of heating and cooling), in some cases, the bonded members cannot withstand the stress and the bonded members may be damaged. In addition, when the pressure at the time of bonding is reduced, the bond strength decreases, and bonded members cannot withstand repeated thermal shocks (heat cycle), and peeling may occur between bonded members.

On the other hand, according to the bonding material of the present embodiment, the stress generated at the time of bonding or thermal shock can be relaxed while the bond strength is high by using the bonding material above, so that the bonded members have excellent bond reliability without cracking of the bonded members.

The indentation hardness of the bonding surface between the first member and the second member is preferably less than 900 N/mm², more preferably less than 860 N/mm² (860 N/mm² or less), and even more preferably less than 820 N/mm² (820 N/mm² or less). When the indentation hardness of the bonding surface between the first member and the second member is less than 900 N/mm², the stress is relaxed and no cracks occur in the bonded members even when the bonded body is repeatedly subjected to thermal shock.

The indentation hardness can be adjusted by the amount of the reducing agent in the bonding material, the pressure when the bonding material is pressure-molded, the pressure when bonding, and the atmospheric conditions when bonding (reducing atmosphere or inert atmosphere).

The shear strength of the bonding surface between the first member and the second member is preferably 35 MPa or more, more preferably 45 MPa or more, and still more preferably 55 MPa or more. When the shear strength of the bonding surface between the first member and the second member is 35 MPa or more, the bonding material is difficult to peel off from the bonded members even when a thermal shock is repeatedly applied to the bonded body, and the bond reliability is excellent.

The shear strength can be adjusted by the amount of the reducing agent in the bonding material, the pressure when the bonding material is pressure-molded, the pressure when bonding, and the atmospheric conditions when bonding (reducing atmosphere or inert atmosphere).

The shear strength of the bonded body bonded under an inert atmosphere tends to be slightly lower than the shear strength of the bonded body bonded under a reducing atmosphere. However, the amount of reduction tends to be less than 10%, and the bonded body bonded under an inert atmosphere can exhibit excellent bond strength as well as the bonding material bonded under a reducing atmosphere.

In the bonded body of the present embodiment, in the load displacement curve (vertical axis: kg-horizontal axis: μm) obtained when measuring the shear strength of the bonding surface between the first member and the second member, when the curve from the inflection point to before the load is saturate is approximated by a linear function, it is preferable that the slope of the straight line of the linear function is less than 1. When the slope of the straight line is 1 or more, cracks may occur in the bonded members such as SiC when a thermal shock is applied to the bonded body. On the other hand, when the slope of the straight line is less than 1, the stress applied to the bonded body is relaxed, and the bonded members are less likely to crack.

The bonded body may have a layer of a pressurized bonding material (hereinafter, referred to as “bonding layer”) between the first member and the second member. The thickness of the bonding layer is preferably 50˜800 μm, more preferably 150˜600 μm, and even more preferably 250˜400 μm.

When the thickness of the bonding layer is 50 μm or more, the effect of the bonding layer to relieve stress is easily obtained, and the mechanical strength of the bonded body is improved.

When the thickness of the bonding layer is 800 μm or less, the bond force between the first member and the second member is further excellent, and the mechanical strength of the bonded body is improved.

(Method for Producing Bonded Body)

Examples of the method for producing the bonded body of the present embodiment include a method in which the bonding material is placed between the first member and the second member and pressed to bond the first member and the second member.

In the method for producing the bonded body, the bond conditions are not particularly limited. It can be appropriately selected depending on the material and combination of the first member and the second member.

The bond pressure under an inert atmosphere can be, for example, 1˜80 MPa. The bond temperature under an inert atmosphere can be, for example, 150° C. or higher. The bond time in an inert atmosphere can be, for example, 1 minute or more.

In the method for producing the bonded body described above, the bonding material of the embodiment above is pressed to bond the first member and the second member. Therefore, even when the difference between the linear expansion coefficient of the first member and the linear expansion coefficient of the second member is large, a bonded body having excellent bond reliability can be produced.

(Action Effects)

As described above, according to the bonded body of the present embodiment, since the pressurized material of the bonding material of the embodiment above is provided, even when the difference in the coefficient of linear expansion between the bonded members is relatively large, voids and cracks are less likely to occur, and bond reliability is excellent.

Further, according to the bonded body of the present embodiment, since the pressurized material of the bonding material of the embodiment above is provided between the first member and the second member, the bonded body of the present embodiment can exhibit excellent bond strength even when the bond is carried out in an inert atmosphere.

Although some embodiments of the present invention have been described above, the present invention is not limited to such specific embodiments. In addition, the present invention may be added, omitted, replaced, or otherwise modified within the scope of the gist of the present invention described in the claims.

### EXAMPLES

Hereinafter, the effect of the present invention will be described in detail by verification tests. The present invention is not limited to the contents of the following verification tests.

(Explanation of Member to be Bonded and Abbreviations Used)
first member to be bonded: SiC (5 mm square, thickness: 200 μm) with Au plating
second member to be bonded: oxygen-free copper plate C1020 (20 mm square, thickness: 2 mm)
Inert atmosphere: 100% by volume nitrogen gas

The average particle size of the fine copper particles and the coarse copper particles was measured by SEM (scanning electron microscope).

The “mass oxygen concentration” of copper particles was measured by an oxygen-nitrogen analyzer (“TC600” manufactured by LECO).

The “mass carbon concentration” of copper particles was measured by a carbon-sulfur analyzer (“EMIA-920V” manufactured by HORIBA, Ltd.).

### Test Example 1

(Producing of Bonding Material)

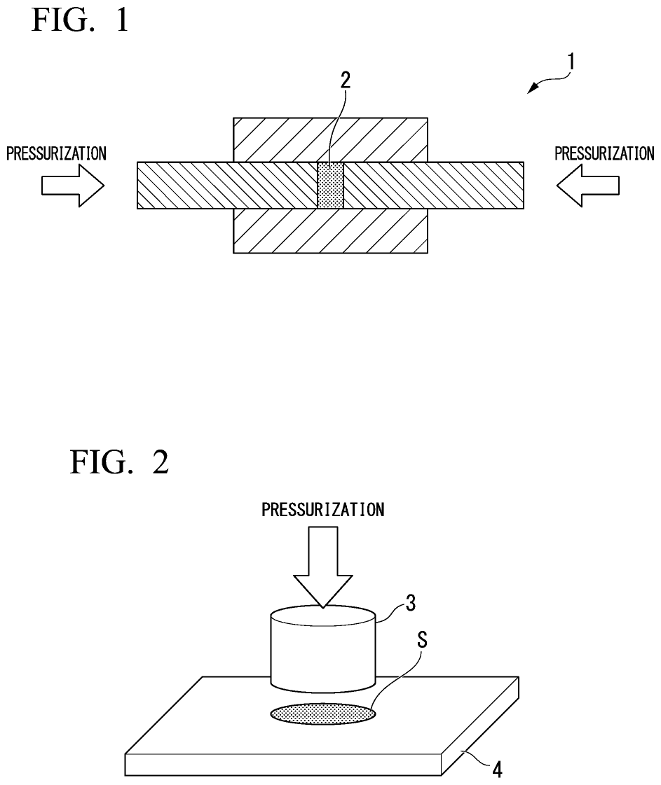

A bonding material having a sheet shape was produced using a jig 1 shown in FIG. 1.

Specifically, first, fine copper particles obtained by the production method disclosed in Japanese Patent No. 4304221 was prepared as a raw material. As a result of measuring the average particle diameter of the obtained fine copper particles, it was 110 nm. The ratio of the mass oxygen concentration of the obtained fine copper particles was 0.25% by mass·g/m², and the ratio of the mass carbon concentration was 0.03% by mass·g/m².

Further, as the coarse copper particles, “MA-C03KP” manufactured by Mitsui Mining & Smelting Co., Ltd. (average particle size: 3.8 μm, tap density: 5.26 g/cm³) was prepared.

Next, the fine copper particles and the coarse copper particles were mixed at a mass ratio of 7.5:2.5, 6 parts by mass of ethylene glycol was added as a reducing agent to 100 parts by mass of the mixed copper powder, and self-revolution was performed. The mixture was stirred with a rotation-revolution-type mixer to obtain mixed particles.

Next, as shown in FIG. 1, the mixed particles 2 were put into a center hole having a diameter of 8 mm in a cylindrical jig 1 having a length of 50 mm and being made of tungsten carbide. Next, a cylinder which is made of tungsten carbide and has a diameter of 8 mm was inserted perpendicularly into the center hole from both ends of the center hole of the jig 1 and pressed to form a sheet.

The pressure-molding was carried out in the air at room temperature for 5 minutes under the condition of a pressure of 17.5 MPa. As a result, a bonding material having a sheet shape, and a diameter of 8 mm and a thickness of 250 μm was obtained. The amount of ethylene glycol in the bonding material having a sheet shape was 5.7% by mass.

(Producing of Bonded Body)

As shown in FIG. 2, the first member 3 and the second member 4 were bonded using the bonding material S having a sheet shape obtained.

First, the bonding material S having a sheet shape was pressurized at 300° C. for 5 minutes at a bond pressure of 40 MPa under an inert atmosphere to bond the first member 3 and the second member 4 to produce a bonded body.

(Shear Strength)

The shear strength of the bonded body was measured using a bond tester (manufactured by Dage, “4000Plus”). The tool height was 100 μm and the tool speed was 200 μm/s. The results are shown in Tables 1 and 2 below.

(Thermal Shock Test)

One cycle of the thermal shock test includes a temperature raising step of heating the bonded body from −40° C. to 150° C. for 30 minutes and a temperature lowering step of cooling the bonded body from 150° C. to −40° C. for 30 minutes. Thermal impact tests were performed up to 500 cycles. The presence or absence of peeling of the bonding layer and cracking of the SiC chip was observed by an ultrasonic flaw detector (SAT) every 100 cycles. In Tables 1 and 2, when the bonding layer was peeled off or the SiC chip was cracked, the reliability is denoted by “x”, and when the bonding layer was not peeled off and the SiC chip was not cracked, the reliability is denoted by “◯”.

(Hardness Test)

Only the bonding material was bonded on the second member using the same bonding material under the same bonding conditions shown in Table 1, and the hardness of the bonding material obtained was measured by a hardness tester (Dynamic ultra-micro hardness tester manufactured by Shimadzu Corporation, “DUH-211”). The results are shown in Tables 1 and 2 below.

(Load Displacement Curve)

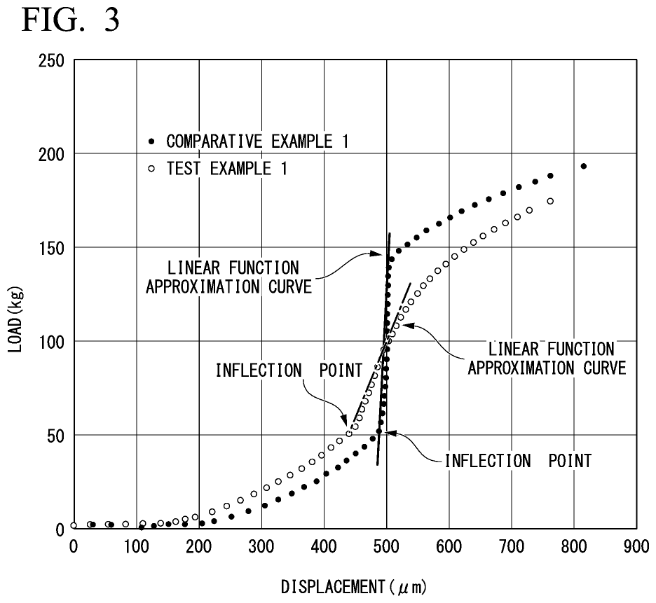

A Load displacement curve (vertical axis: kg-horizontal axis μm) was obtained by measuring the shear strength of the bonding surfaces of the first member and the second member. Next, the curve from the inflection point to before the load saturates was approximated by a linear function, and the slope of the straight line of the linear function was obtained (see FIG. 3). The results are shown in Tables 1 and 2 below.

### Test Examples 2˜8, and Comparative Examples 1 and 2

Except for the conditions shown in Tables 1 and 2, the bonding materials and bonded bodies of Test Examples 2˜8 and Comparative Examples 1 and 2 were produced in the same manner as in Test Example 1 described above.

TABLE 1

| | Test | Test | Test | Test | Test |
|---|---|---|---|---|---|
| | example | example | example | example | example |
| | 1 | 2 | 3 | 4 | 5 |
| Fine copper particles: | 7.5:2.5 | 5:5 | 5:5 | 7.5:2.5 | 7.5:2.5 |
| Coarse copper | | | | | |
| particles | | | | | |
| Shape of coarse | flake | flake | flake | flake | micro |
| copper particles | | | | | |
| Average particle | 3.8 | 3.8 | 3.8 | 6.1 | 3.5 |
| diameter of coarse | | | | | |
| copper particles [μm] | | | | | |
| Bond temperature | 300 | 300 | 325 | 300 | 300 |
| [° C.] | | | | | |
| Bond pressure [MPa] | 40 | 40 | 40 | 40 | 40 |
| Bond time [min.] | 5 | 5 | 5 | 5 | 5 |
| Bond atmosphere | 100% | 100% | 100% | 100% | 100% |
| | N₂ | N₂ | N₂ | N₂ | N₂ |
| Shear strength [MPa] | 69 | 40 | 55 | 62 | 72 |
| Chip crack | Absence | Absence | Absence | Absence | Absence |
| Peeling at bonding | Absence | Absence | Absence | Absence | Absence |
| surface | | | | | |
| Reliability | ○ | ○ | ○ | ○ | ○ |
| Indentation hardness | 853 | 698 | 803 | 817 | 879 |
| [N/m²] | | | | | |
| Slope of the linear | 0.71 | 0.39 | 0.35 | 0.66 | 0.88 |
| function | | | | | |
| approximation curve | | | | | |
| after the inflection | | | | | |
| in the load- | | | | | |
| displacement curve | | | | | |

TABLE 2

| | | | | Com- | Com- |
|---|---|---|---|---|---|
| | Test | Test | Test | parative | parative |
| | example | example | example | example | example |
| | 6 | 7 | 8 | 1 | 2 |
| Fine copper | 9:1 | 7.5:2.5 | 7.5:2.5 | 10:0 | 7.5:2.5 |
| particles:Coarse | | | | | |
| copper particles | | | | | |
| Shape of coarse | flake | flake | flake | — | flake |
| copper particles | | | | | |
| Average particle | 3.8 | 3.8 | 3.8 | — | 12.1 |
| diameter of | | | | | |
| coarse copper | | | | | |
| particles [μm] | | | | | |
| Bond | 300 | 325 | 300 | 300 | 300 |
| temperature | | | | | |
| [° C.] | | | | | |
| Bond pressure | 40 | 40 | 20 | 40 | 40 |
| [MPa] | | | | | |
| Bond time | 5 | 5 | 5 | 5 | 5 |
| [min.] | | | | | |
| Bond | 100% | 100% | 100% | 100% | 100% |
| atmosphere | N₂ | N₂ | N₂ | N₂ | N₂ |
| Shear strength | 73 | 72 | 32 | 76 | 22 |
| [MPa] | | | | | |
| Chip crack | Presence | Presence | Absence | Presence | Absence |
| Peeling at | Presence | Presence | Presence | Presence | Presence |
| bonding surface | | | | | |
| Reliability | x | x | x | x | x |
| Indentation | 957 | 988 | 632 | 1028 | 446 |
| hardness [N/m²] | | | | | |
| Slope of the | 2.6 | 1.20 | 0.40 | 5.3 | 0.19 |
| linear function | | | | | |
| approximation | | | | | |
| curve after the | | | | | |
| inflection | | | | | |
| in the load- | | | | | |
| displacement | | | | | |
| curve | | | | | |

In the bonded body of Test Examples 1˜5, the bonding material contained the fine copper particles, the coarse copper particles, and the reducing agent in an appropriate ratio (mass ratio between the fine copper particles and the coarse copper particles is in a range of 5:5˜7.5:2.5), and the bond conditions were appropriate. Therefore, the indentation hardness of the bonding material was less than 900 N/mm², and the slope of the linear function approximation curve after the inflection in the load displacement curve of the bonded body produced was less than 1. As a result, the bond structure was excellent in stress relaxation ability, and the bond reliability was excellent even though the members bonded to each other have a difference in coefficient of linear expansion of 4 times or more.

In the bonded body of Test Example 6, the bonding material contained the fine copper particles, the coarse copper particles, and the reducing agent, but the mass ratio between the fine copper particles and the coarse copper particles was outside a range of 5:5˜7.5:2.5. Therefore, the indentation hardness of the bonding material was 900 N/mm² or more, and the slope of the linear function approximation curve after the inflection in the load displacement curve of the bonded body produced was 1 or more. As a result, there was no stress relaxation ability, and the SiC chip cracked and the bonding surface peeled off, resulting in poor bond reliability.

In the bonded body of Test Example 7, the bonding material contained the fine copper particles, the coarse copper particles, and the reducing agent, and the mass ratio between the fine copper particles and the coarse copper particles was in a range of 5:5˜7.5:2.5. However, bonding conditions were not appropriate. Therefore, the indentation hardness of the bonding material was 900 N/mm² or more, and the slope of the linear function approximation curve after the inflection in the load displacement curve of the bonded body produced was 1 or more. As a result, there was no stress relaxation ability, and the SiC chip cracked and the bonding surface peeled off, resulting in poor bond reliability.

In the bonded body of Test Example 8, the bonding material contained the fine copper particles, the coarse copper particles and the reducing agent, and the mass ratio of the fine copper particles and the coarse copper particles was in a range of 5:5˜7.5:2.5. However, the bond conditions were not appropriate. As a result, the shear strength was less than 35 MPa, so that peeling occurred on the bonding surface, and the performance of the bonding material could not be exhibited.

In the bonded body of Comparative Example 1, the bonding material did not contain the coarse copper particles. Therefore, chip cracking and peeling were confirmed. It was also found that the bond was inferior in reliability.

In the bonded body of Comparative Example 2, the particle size of the coarse copper particles contained in the bonding material exceeded 11 μm. Therefore, the sinterability was poor and the shear strength was less than 35 MPa. As a result, peeling occurred on the bonding surface, and the performance of the bonding material could not be exhibited.

### INDUSTRIAL APPLICABILITY

The bonding material, the method for producing the bonding material, and the bonded body of the present invention can be industrially used for bonding electronic components. Specifically, a bonding application of parts such as a board and an element in a high temperature environment at which it is difficult to use a material such as solder, such as in an electronic device such as a power device, is an exemplary example.

### EXPLANATION OF REFERENCE NUMERALS

1 jig
2 mixed particles
3 member to be bonded
4 material to be bonded
S bonded body

1. A method for producing a bonding material having a plate shape or a sheet shape,
wherein the method includes:
a mixture producing step in which fine copper particles having an average particle diameter of 300 nm or less, coarse copper particles having an average particle diameter of 3 μm or more and 11 μm or less, and a reducing agent which reduces the fine copper particles and the coarse copper particles are mixed to produce a mixture: and
molding step in which the mixture is formed in a plate shape or a sheet shape.
